(19) United States
(12) Patent Application Publication
(10) Pub. No.: US 2011/0121074 A1
(43) Pub. Date: May 26, 2011

(54) METHOD FOR REPAYMENT OF ELEVATOR INVESTMENT COSTS

(76) Inventor: Simo MAKIMATTILA, Espoo (FI)

(21) Appl. No.: 12/974,847

(22) Filed: Dec. 21, 2010

Related U.S. Application Data
(63) Continuation of application No. 10/743,744, filed on Dec. 24, 2003.
Application No. 10/743,744 is a continuation of application No. PCT/FI02/00507, filed on Jun. 11, 2002.

(30) Foreign Application Priority Data
Jun. 28, 2001 (FI) 20011393

(51) Int. Cl. G06K 5/00; B66B 1/52

(52) U.S. Cl. 235/382; 187/389

(57) ABSTRACT

The invention relates to a method for repayment of the investment costs of an elevator on the basis of personal identification of the passenger, by providing the aforesaid passenger with a card comprising the personal data of the aforesaid passenger, on the basis of which card a remote reader installed in connection with the elevator identifies the passenger.

This application is a Continuation of copending application Ser. No. 10/743,744 filed on Dec. 24, 2003, which claims priority to PCT International Application No. PCT/FI02/00507 filed on Jun. 11, 2002, which designated the United States, and on which priority is claimed under 35 U.S.C. §120, and of Finnish application 20011393 filed on Jun. 28, 2001 in Finland, the entire contents of both of which are hereby incorporated by reference.

The present invention relates to a method for repayment of the investment costs of an elevator on the basis of personal identification of a passenger wanting to enter the elevator, by providing the aforesaid passenger with a card comprising the personal data of the aforesaid passenger, on the basis of which card a remote reader installed in connection with the elevator identifies the passenger.

The method of the present invention relates to installing an elevator in a building where no elevator has been installed before. The problem is the technical solution and placement of the elevator in the existing structures so that the investment and operation costs of the elevator could be financed.

A solution generally applied to solve the parameter is one in which the shareholders of the housing corporation of the building pay the entire elevator investment as a single payment or in installments included in the so-called maintenance charge. In this case it is generally not possible to take into account who uses the elevator and how much each shareholder of the housing corporation uses it. In other words, even those shareholders of the housing corporation who for one reason or another do not often use the elevator have to contribute to repayment of the elevator investment costs.

Prior art is described in JP specification abstract 11060084 (B66B 1/14), which discloses an elevator controller based on an elevator user identification function. This controller comprises a card reader placed inside the elevator car. The card reader identifies the user entering the elevator car and accepts a registered destination call. Use of the elevator car is not allowed until a registered destination call is accepted on the basis of identification. After the identification, a call registering lamp inside the elevator car shows the floor given by the user. In addition, various types of elevator systems subject to charge are commonly used.

The problem with prior-art solutions is that the elevator investment costs can not be amortized and paid on the basis of intensity of elevator use and identification of passengers using the elevator.

In applications based on intelligent cards, the problem is that the remote reading function is difficult to implement due to the large numbers of passengers involved, because in this case the distance requirement for non-contact reading is difficult to meet.

The object of the present invention is to eliminate the disadvantages encountered in the above-mentioned prior-art solutions.

In precise terms, the method of the invention for repayment of elevator investment costs on the basis of personal identification of the passenger is characterized by each passenger of an elevator being charged via intelligent card for using the elevator on the basis of the number of times of use in such manner that the investment costs of the aforesaid elevator are repaid.

By applying the method of the invention, significant advantages are achieved as compared with prior art solutions.

An elevator according to the present invention is better applicable for satisfying the requirements of different user groups. In addition, it is possible to implement the sharing of elevator investment costs according to elevator use on an elevator passenger specific basis. Likewise, it is possible to define an appropriate basis of compensation for the use of the elevator. In particular, the method can be developed further so that, by showing the same intelligent card or ticket card, a person can move and travel even on other means of transport, such as trains, ships, airplanes, street cars, etc.

In particular, by applying the method of the present invention for using an elevator, it is possible to shorten the repayment time of the elevator investment.

In addition, the above-mentioned elevator is better suited to satisfy the requirements of different types of user groups. In a building there are always people who use the elevator to different extents. This may be due e.g. to travels or the dwelling being located on a low floor. Thus, the present invention makes it possible to achieve equitable repayment of elevator investment costs on a passenger and resident specific basis.

According to a preferred embodiment of the invention, the aim is to cover the investment costs of a new elevator to be installed in a building entirely on the basis of elevator use. The invention consists of a method for repayment of elevator investment costs on the basis of passenger identification. This is implemented by providing the aforesaid passenger with a card comprising the personal data of the aforesaid passenger, by which card a remote reader installed in connection with the elevator identifies the aforesaid passenger who wants to enter the elevator.

According to the invention, each passenger of the aforesaid elevator is charged for using the elevator on the basis of the number of times of use via the aforesaid card comprising the personal data of the passenger wanting to enter the elevator, in such manner that the investment costs of the aforesaid elevator are repaid.

In addition, according to an embodiment of the method of the invention, the aforesaid intelligent card gives the passenger access to the elevator. The intelligent card also contains storable data. On an intelligent card like this, it is possible to store in its electronic memory a sum of money corresponding to a given payment made, which sum is decremented by the card reader each time the person travels on the elevator.

The intelligent card would always have updated account balance information.

According to the invention, the passengers are charged different sums for the use of the aforesaid elevator depending on the destination floor, which is advantageous when the passenger uses destination calls. Thus, for example, traveling to a higher floor would obviously be more expensive to the passenger than traveling to a lower floor. Likewise, according to an embodiment of the invention, the degrees of mobility of user groups of different ages relating to elevator use are taken into account. The aforesaid mobility refers to the ability of a person to move and to the impairment of said ability e.g. due to age or illness.

The intelligent card can be so implemented that the charge to the elevator passenger can also be made using different currency units. Therefore, a foreign passenger will not have to exchange money in order to travel on the elevator if he uses an intelligent card like this.

In addition, according to a preferred embodiment of the invention, this card identifying the passenger wanting to enter the elevator is preferably a remotely readable ticket card of the size of a credit card, and a remote reader installed in the elevator identifies the passenger entering the elevator by the ticket card held by the passenger.

This aforesaid ticket card may be e.g. optically readable. When a passenger is entering the elevator, he shows the card to the card reader, whereupon the data loaded or stored on the card are transferred to the elevator control system.

The information stored on the aforesaid intelligent card and ticket card includes e.g. the person's name, user identifier and information regarding travel rights, such as e.g. the floors to which the person may travel on the elevator.

Other cards applicable in the method of the invention for identifying the passenger wanting to enter the elevator include identity cards, such as personal identification card, health insurance card, student card, driver's license and party membership card. The data regarding the passenger wanting to enter the elevator and identified on the basis of these cards are recorded in the elevator control system.

On the other hand, according to an embodiment of the invention, the personal identification may be based on several different cards that are readable either by optical, magnetic or electric means. Moreover, the personal identification may be based on several cards simultaneously. Such a situation may arise when the identity of the person wanting to enter the elevator is to be verified with absolute reliability by means of several cards. Such a situation might occur e.g. in an elevator system intended for use by a given political student organization, in which case the remote reader will have to read data both from identity cards, student cards and party membership cards.

Thus, personal identification as described above may be based on several different cards that are readable by either optical, magnetic or electric means.

On the other hand, the means identifying the elevator user need not be of a card-like form at all; instead, it may also consist of an identifying object that is easy to be carried by the elevator passenger. Such an object might be e.g. an intelligent sticker or intelligent wristband or a bluetooth or equivalent.

According to the invention, the remote reader installed in the elevator for reading a card containing the personal data of the passenger wanting to enter the elevator is mounted in the first place in connection with a call button, in which case the aforesaid passenger can enter a call by showing the aforesaid card, whereupon the elevator control system will issue a call corresponding to the data on the card. On the other hand, the person wanting to enter the elevator can enter a call by showing the card and issuing a call by pressing an actual call button.

This aforesaid remote reader can be installed on an elevator landing, in which case a landing call is given by showing the card, on the basis of which the control system will bring the elevator car to the corresponding floor.

According to the invention, all data are updated to the maintainer of the elevator via the remote reader installed on the elevator. Thus, an interest group, e.g. a social authority, can receive information regarding the aforesaid elevator. This is advantageous e.g. in a residential building intended for old or handicapped people.

Likewise, the aforesaid remote reader registers the times of elevator use by each passenger separately. Therefore, from this information regarding the times of elevator use by each passenger, it will be easy to maintain statistics by collecting the data relating to the times of elevator use by each passenger using the elevator from the elevator group control level and from the group control computer.

The aforesaid remote reader also registers the floors of departure and arrival of each passenger separately. Therefore, it is possible to collect reliable statistical data about use of the elevator on the basis of intensity of use, which data can be utilized e.g. in allocating the billing for the use of the elevator, in the planning of passenger-specific discounts and in access surveillance.

In the foregoing, the invention has been described by way of example while different embodiments of the invention are possible within the scope of the inventive idea defined in the claims.

1.-13. (canceled)

14. A method for repaying the investment costs of an elevator based on personal identification of a passenger wishing to use the elevator, the method comprising:
providing said passenger with an access device having stored thereon the personal data of said passenger;
providing an access device reader mounted in connection with a call button;
generating an elevator call through said reader based on the personal data such that the elevator call is generated when the reader reads the access device;
registering elevator use time separately for each passenger based on data collected by the reader when said elevator call is generated;
collecting statistical data regarding elevator use based on registered elevator use times; and
charging each passenger of said elevator based on their registered use times such that the investment costs are repaid.

15. The method of claim 14, wherein said reader device generates said elevator call by reading the access device, validating the personal data, and automatically generating an elevator call after the personal data is validated.

16. The method of claim 14, wherein said reader device is connected to a floor selection device and the method further comprises allowing selection of a destination floor via said floor selection device in accordance with said passenger's identifying data after said generating an elevator call.

17. The method of claim 16, wherein said generating an elevator call includes automatically generating an elevator call with a default destination floor selection based on the personal data.

18. In a fee-based elevator access system designed for the repayment of costs associated with an elevator installation in a facility, said system having a reader device to enable and charge for passenger elevator use, an access device designed to interact with said reader device for the purpose of passenger access, said access device comprising:
a data storage unit containing unique identifier data associated with identifying data about a passenger, said identifying data comprising at least one of a unique identification number, a name, an address, relevant age and health information, and relevant group affiliation or access permission information; and
a reader interaction unit allowing said access device to convey information to said reader device,
wherein said reader device, by interacting with said reader interaction unit, is able to access and convey identifying data from the data storage unit, thereby enabling a passenger equipped with said access device to utilize an elevator for a fee and to access specific destinations, both the fee assessed and the available destinations being based on said identifying data, and
wherein said reader device automatically generates an elevator call when said reader interaction unit interacts with said reader device; and
wherein an appropriate fee is assessed to each passenger upon the interaction of said reader device and said access device on a passenger-specific basis such that repayment costs are equitably distributed wherein the cost distribution shortens the time period for full repayment of elevator investment costs.

19. The access device of claim 18, wherein said reader device is connected to a floor selection device and where said floor selection device is configured to allow a passenger to select a destination floor for a generated elevator call from a set of available destination floors based on said identifying data.

20. The access device of claim 18, wherein said access device comprises a transponder for use in a radio-frequency identification system such that said personal data is associated with the radio-frequency identification of said transponder.

21. The access device of claim 18, wherein said access device comprises a ticket card having a magnetic stripe whereon a reference to said personal data is encoded.

22. The access device of claim 18, wherein said access device comprises an optically-readable access code affixed to a surface, said personal data being associated with said access code.

23. The access device of claim 18, wherein said access device is an identity card or a personal identification card or a health insurance card or a student card or a driver's license or a party membership card.

24. The access device of claim 18, wherein said access device comprises an electronically readable sticker that a passenger may apply a surface, said sticker being associated with said personal data.

25. The access device of claim 18, wherein said access device comprises a computer-readable medium contained within or accessible by a wireless communication device carried by said passenger, said communication device transmitting said personal data to said reader device through Bluetooth, infra-red or telephone communication.

26. A fee-based elevator-access system designed for the repayment of costs associated with an elevator installation in a facility, said system comprising:
an information reading device designed to collect identifying information from passengers wishing to us an elevator, said device interacting with an elevator control system whereby access to the elevator and to elevator service levels is controlled, and an elevator billing system whereby passengers are charged for elevator use based on said identifying information;
an access device designed to interact with said information reading device, said access device being associated with identifying information of a passenger,
wherein said passenger may obtain access to an elevator to the extent that said passenger is authorized to use said elevator by allowing said reading device to
retrieve identifying and billing information associated with said access device and
automatically generate an elevator call when said access device is read; and
wherein an appropriate fee is assessed to each passenger upon the interaction of said reader device and said access device on a passenger-specific basis such that repayment costs are equitably distributed wherein the cost distribution shortens the time period for full repayment of elevator investment costs.

27. The system of claim 26, wherein said reading device is connected to a floor selection device such that the floor selection device is configured to allow selection of a destination floor via said floor selection device in accordance with said passenger's identifying data after said reading device automatically generates an elevator call.

28. The system of claim 27, wherein said reading device automatically generates an elevator call with a default destination floor selection based on the personal data.

29. The system of claim 26, wherein said reading device is installed at an elevator lobby or an entrance.

30. A method for repayment of the investment costs of an elevator for a new elevator installation, said method comprising the steps of:
providing an access device that allows a passenger to access the elevator;
collecting identifying data of a passenger wanting to use the elevator by reading an access device associated with identifying data of said passenger with a reader device connected to a control system for said elevator, wherein said identifying data comprises at least one of a unique identification number, a name, an address, relevant age and health information, and relevant group affiliation or access permission information;
identifying the passenger based on said identifying data;
determining the desired destination floor for said passenger;
verifying that said passenger is authorized to access said elevator to reach said destination floor wherein elevators said passenger may use and destination floors said passenger may reach using any one of said elevators are determined based on group affiliation, address, or access permission information contained in said identifying data;
transmitting passenger identification, authorization and desired floor information to said elevator control system for processing;
charging said passenger based on said identifying data, wherein said charging comprises:
tracking elevator usage by said passenger,
determining an appropriate billing party based on passenger identification, and
assessing a usage charge to said passenger, after said determining and said verifying steps, based on factors including at least one of frequency of use, length of elevator ride, time and date of use, number of rides, relevant passenger affiliation, passenger age or health information, passenger address, and direction of elevator travel such that repayment costs are distributed amongst elevator users on a passenger-specific basis; and
automatically generating an elevator call in accordance with said identifying data via an elevator call device connected to said reader device when the identifying data on the access device is read and verified by the elevator control system via said reader device.
